(19) United States
(12) Patent Application Publication
(10) Pub. No.: US 2007/0022296 A1
(43) Pub. Date: Jan. 25, 2007

(54) Electronic data registry and certification system and method

(76) Inventors: Gordon Caverly, Byron, MI (US); Ronald Dehaas, Corunna, MI (US)

Correspondence Address: DICKINSON WRIGHT PLLC, 1901 L. STREET NW, SUITE 800, WASHINGTON, DC, 20036, US

(21) Appl. No.: 11/187,897

(22) Filed: Jul. 25, 2005

(51) Int. Cl. H04L 9/00

(52) U.S. Cl. 713/178

(57) ABSTRACT

A method and system of capturing, validating, and certifying (or otherwise authenticating) electronic data samples on which consumers may rely. It includes a system and method for sampling, validating, verifying, storing, registering, and certifying electronic transmissions, such as websites, Internet packets or data from any Internet protocol, e-mails, electronic files, instant messages, encrypted data, streaming video, and the like. Also may be the inclusion of an authentication step to authenticate the certification by means such as tamperproof embedding of a service mark, a secret code requirement to open the document, and encryption. Other important aspects may include, comparison of two datasets, date and time stamping are recorded using a stratum level clock, data samples are collected at at least two separate geographic locations, each providing identical copies of said data sets.

This invention is related to a process of capturing, validating, and certifying electronic transmissions, and more particularly to a system and method for sampling, validating, verifying, storing, registering, and certifying electronic transmissions, such as websites, Internet packets or data from any Internet protocol, e-mails, electronic files, instant messages, encrypted data, streaming video, and the like.

### BACKGROUND OF THE INVENTION

It is becoming increasingly desirable to provide accurate and authentic or certified evidence of content on a website, or other electronic transmissions, at a particular point in time. For example, in a court of law, where the rules of evidence apply, time sensitive Website content may be admissible as evidence in a contested matter once it has been authenticated or certified. Admissibility may also include establishing the evidence as either non-hearsay, an exception to hearsay, and whether it satisfies the rules of evidence concerning contents of writings.

By way of example, a party to a lawsuit may wish to establish evidence of website content on a particular date. Authentication/certification may include calling a witness to testifying as to the process or system used to manage content. If the content is being offered to merely show what appeared on the website at that particular time or is shown as a data compilation of regularly conducted business activity, the hearsay rule may not apply. And finally, the evidence may need to be offered as an original or an acceptable duplicate. Data should be stored in a computer or similar device, any optical or magnetic storage device, any printout, or other output accurately retrievable or readable by sight.

Although there are known “snapshot” programs in the art that enable screen capture, those programs are neither comprehensive nor believed to be certifiably accurate. Typical use of a “snapshot” program could include capturing a “snapshot” of particular electronic transmission or content that is then stored on their servers with the hope that it would satisfy the rules of evidence. Nevertheless, these “snapshots” do not include an independent host.

For example, the U.S. National Archives and Records Administration has requested agencies to “Configure (e.g., mirror) Website content (or the portions to be transferred to NARA) in [their] developmental environment (e.g., another server) . . . ” and further “identify all the files that need to be copied . . . ” and then to “copy the files to the appropriate media preserving the file and directory structures.” found, as of the date of filing this application, at the following Uniform Resource Locator (URL): www.archives.gov/records_management/cio_link. While such preservation of snapshots may be valuable for historical purposes, it provides neither security from tampering, nor security in transfer of information.

As these snapshots are mostly an informal historical record and not with the intent to be admissible as evidence in court, there is little or no standardization of procedures for capturing, time-stamping, verifying, storing, and authenticating such electronic data. Insofar as the historical record goes, snapshots lack non-website archiving, and also lack archiving of secure or password-protected sites, which often are the very sites that lend themselves to potentially critical and contested content. In short, such snapshot endeavors lack intent of establishing a certifiable record for use in, for instance, a court of law.

U.S. Pat. No. 6,708,227 to Cabrera et al. provides for the gathering of snapshots of website (and perhaps other electronic transmissions) for the purpose of backing up computer systems. However, this method and system does not certify content from the various snapshot providers, nor does it provide certification methods of its own provision.

US application 2004/0015432 to Lewis describes a system of self-certifying affidavits, but provides no method or system for independent verification and certification. Lewis certifies the content of resume data pertaining to job seekers, but is not intended for certification even of that limited application in a lawsuit. US application 2002/0147659 to Hong et al. provides a portal to only certified Web sites where any products or services listed through those Web sites are certified as genuine, but once again, this method is not intended for certification to purposes of admissibility as evidence in a court of law. Furthermore, this method does not provide snapshots of actual electronic data transmission for the purposes of verification and certification of content.

In summary, voluntary and/or historical archiving of snapshots known in the art are currently suited only for historical purposes, or for the purpose of backing up computer systems. None are known to offer a method for sampling, validating, verifying, storing, registering, and authenticating electronic transmissions that would be suitable for admission as evidence in a court of law. There is thus a desire and need in the art for providing an independent and authentic (certified) record of electronic data. Such data may include websites, Internet packets or data from any Internet protocol, emails, files, instant messages, encrypted data, streaming video, and the like.

### SUMMARY OF THE INVENTION

The present invention generally relates to a process of capturing, validating, and certifying (or otherwise authenticating) electronic data samples on which consumers may rely. It includes a system and method for sampling, validating, verifying, storing, registering, and certifying electronic transmissions, such as websites, Internet packets or data from any Internet protocol, e-mails, electronic files, instant messages, encrypted data, streaming video, and the like.

Accordingly, it is an important aspect of the invention to provide a system and method to provide confirmation of content of an electronic data sample. The system could capture an electronic data sample, and have a database interface for accessibly storing said data sample upon initiation of a system request, an interface to accurately date and time stamp contemporaneously received data sample, an interface to compare content of predetermined data sample sets, and a notification report upon detection of predetermined differences.

A related further aspect of the invention relates to the provision of a method and system to include a third party interface to verify data sample content using predefined parameters, to generate a system verification report.

In accordance with another aspect of the invention, the system and method may further comprise sampling from at least one other data sample, such as a data sample captured contemporaneously by another service provider server at a different geographic location. System requests may be made by service provider or customer.

Another important aspect of the invention may be the inclusion of an authentication step to authenticate the certification by means such as tamperproof embedding of a service mark, a secret code requirement to open the document, and encryption.

Other important aspects of the present invention may include, comparison of two datasets, date and time stamping are recorded using a stratum level clock, data samples are collected at at least two separate geographic locations, each providing identical copies of said data sets.

Additional aspects and advantages of the invention will become apparent from the following detailed description, the drawings, and the appended claims.

### BRIEF DESCRIPTION OF THE FIGURES

The foregoing features, as well as other features, will become apparent with reference to the description and figures below, in which like numerals represent like elements, and in which:

FIG. 1 is a block diagram representing a Service Provider request in accordance with the present invention;

FIGS. 2A and 2B are block diagrams representing a Customer and Service Provider Application request capturing customer samples in accordance with the present invention;

FIGS. 3A and 3B are block diagrams representing a Customer and Service Provider Application request capturing competitor samples in accordance with the present invention; and

FIG. 4 is a block diagram representing a certify and verify request in accordance with the present invention.

### DETAILED DESCRIPTION OF THE INVENTION

Prior to the introduction and the proliferation of the World Wide Web the ability to inform, present, track, document, organize, store, file, authenticate, certify and disseminate information content has been in acceptable static forms such as paper copy; printed material, microfilm, video tape recordings, and the like. These standardized methods of documentation are well known and tested in court proceedings.

Subsequent to this time tested and organized process of handling printed media or any media that has demonstrated a static content (retaining it's form, content and definition until a scheduled change) by nature the advent of the Internet and the World Wide Web has created a tremendous void in validating and certifying the transmission, presentation and accurate storage of electronic data content (e-files, e-mails, etc.) in any form (voice, data or video) that is or can be proven without substantial and monumental effort and cost to all parties involved.

The present invention generally relates to a process of capturing, validating, and certifying (or otherwise authenticating) electronic transmissions, and more particularly to a system and method for sampling, validating, verifying, storing, registering, and certifying electronic transmissions, such as websites, Internet packets or data from any Internet protocol, e-mails, electronic files, instant messages, encrypted data, streaming video, and the like.

To assist in understanding the present invention, an illustrated embodiment of present invention is presented, as well as some terms that may generally be defined. The term “Data” may reference any information in an electronic format contained in packets, frames or any other encapsulation format to transmit or receive voice, data or video intelligence through wired, non-wired (fiber, plastic, etc.) or wireless systems over the internet or over private networks regardless of the topology or architecture.

Files may reference the stored or transmitted medium that contains intelligent electronic information in the form of data. Data samples (encrypted or non-encrypted) may include, but not limited to, electronic files, website content, e-mails, newsgroups, MP3s or other audio form, instant messages, streaming video, internet packets, or any internet protocol. This information may also be contained in folders, directories, sub-directories, internal or external storage devices, removable or portable storage devices such as thumb drives, mini hard drives or any of the following architectures;

Network Attached Storage (NAS) is an architecture that allows for large amounts of data to be stored in a common location and can be accessed via networks attached to these devices using multiple operating systems.

Storage Area Networks (SAN) is an alternative architecture that improves on the performance of a NAS device and increases both the access speed and distance design limitations of that architecture.

Service Provider (SP) may reference a company that provides a service to certify/validate/authenticate electronic data through the application the present invention.

Service Provider Application (SPA) may reference software and hardware required to certify/validate/authenticate electronic data.

Customer Application (CA) may reference software and hardware applications of a customer.

Internet Service Provider (ISP) is a common term known in the art. Certify and Verify (C and V) are also known terms of art.

“Date and Time Stamp” is a process that upon receipt of any sampled Data a date and time stamp will be recorded with that data. The accuracy of this process may be ensured through either an internally generated Stratum Level 1 sync clock located in the SP location, through a National Institute of Standards and Technology (NIST) Atomic clock in Boulder Colo., which may be accessed over the internet, or other such means to reliably and accurately record date and time.

Transmission Control Protocol/Internet Protocol (TCP/IP) is a suite of protocols known in the art designed to support Wide Area Networks (WANs) with all the requirements necessary to implement and support multiple networks, as well as routing between multiple networks. The TCP is typically the “hand shaking” event that allows networks to communicate. The IP is a portion of the TCP/IP protocol suite that serves primarily to assign the correct destination address to a data packet.

The following discussion provides a brief general description of a suitable computing environment in which the present invention may be implemented. Although not required, the invention will be described in the general context of computer-executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices. Memory storage devices may include a hard disk, a magnetic disk, optical disk, and the like. It should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A personal computer utilizing the present invention may operate in a networked environment using logical connections to one or more remote computers, such as a remote computer. The remote computer, such as a service provider computer may be another personal computer, a server, a router, a network PC, a peer device or other common network node, and typically includes many or all of the elements described above relative to a personal computer. The logical connections depicted in the figures may include a local area network (LAN) and/or a wide area network (WAN). Such networking environments are commonplace in offices, enterprise-wide computer networks, intranets, and the Internet.

It should be noted that the computer system described above can be deployed as part of a computer network, and that the present invention pertains to any computer system having any number of memory or storage units, and any number of applications and processes occurring across any number of volumes. Thus, the present invention may apply to both server computers and client computers deployed in a network environment, having remote or local storage.

One embodiment of the present invention may be developed primarily for an Internet-based system, but it should be realized by those skilled in the art that other types of systems are possible, such as an internally operated intranet. Such systems are currently in place in very large corporations. Nevertheless, for illustrative purposes, an Internet-based system and operation is described, residing on a SP's Internet server providing database storage, processing capability, access, and security. The invention also provides for interaction with other server-based applications such as E-mail services, and the like. The invention has a data base system providing for interactive access of multiple parties and categories of parties, in addition to the system administrator.

Generally, the present invention allows for validating and certifying (VC) a customer's at-risk data. “At-risk” data is that data considered by the customer to be of such content that if presented to a customer or made available for public consumption and was incorrect or construed to be incorrect by any consumer could lead to or be entered into a public forum or a court of law in determining the valid use by the consumer of that data and any related liabilities suffered by the consumer through the use of that data.

For example, the present invention process may be initiated when a customer desires to certify that data presented on its web or e-mail servers is actually what it was represented to be when available to the public. A Service Provider (SP) may provide, using aspects of the present invention, any of the following:
Capturing any at-risk data (voice, data, video, and the like), whether it is on the customer's website or through any of their e-mail or attachments.
A predetermined frequency of which the data is sampled and recorded, which may be a minute, hour, day, week or streaming data, etc.
A predetermined storage term of data backup (for example if the customer is concerned about a suit for a breech of contract, the term of storage could be the time to let a statute of limitations run on any claims on the contract)
A predetermined data storage format to be sampled or recorded
Accurate time and date stamping of the sampled data

The architecture supporting the present invention may be any hardware/software devices that support the accurate capture, tracking, documenting, recording, validating, verifying, comparison, time stamping and storing of this data. This process may be used to afford a high level of protection for those companies desiring to implement a third party process that will guarantee and certify the content of data on its web or e-mail servers in case of any potential litigation incurred due to that content that has been made available to the public.

Hardware to practice the present invention may be any industry standard or proprietary hardware such as file servers, switches, routers, storage area networks, network area storage devices or local or remote storage processes, whether they are web based or local in concept. The software (standard or proprietary software languages) may be developed as a client and or server application (independent of specific hardware). It may run simultaneously on both the Service Providers (SP) Network Operations Center (NOC) servers and the customers (clients) web/e-mail servers.

Each application may access a reliable and accurate date and time stamping process known in the art, such as a Stratum Level 1 atomic clock. In any event, the date and time stamping process used must provide the accuracy to ensure the captured data is time and date stamped as it was being presented to the general public. This capture and recording action may take place simultaneously at the client site and a remote general public terminal site (i.e., may be located within the SP NOC) that displays the same content as that being presented by the customer's web/e-mail server. In essence, the data may be captured from at least one site location(s) and stored for validation and comparison prior to being recorded. It is possible that a user of the present invention may configure it to capture only data from one site. For example, a website could be captured that is stored on its computer and nowhere else. A customer running/operating the client software application would predetermine, which at-risk data is to be sampled and the frequency of such sampling. Such predetermination could be part of a written contract between the service provider and the customer.

The architecture and topology deployed to support this process will be any combination of Network Operations Center, Local Operations Center or a web based operations. The traditional service provider architecture and topology will be a fault tolerant virtual ring of at least two NOC's strategically centered geographically within the United States utilizing state-of-the-art hardware, backup and network switch and routing devices.

A typical mature operation could locate a NOC on the east coast, mid-west and west coast. Each NOC would provide a complete backup and record of every data capture from each customer operation. This will require that each NOC is networked together for transmission of data and synchronizing of the Stratum clock to ensure accurate time stamping, receipt and recording of the data. This would allow a higher degree of reliability that the data would be captured as designed even with a threat of large power outages, large scale natural disasters and the like.

The Validating and/or Certifying (VC) Process

The engine and intelligence for the VC software processes of the present invention may use any of a variety of programming languages known in the art (For example products sold under the trade names ORACLE, MS-SQL, C++, VISUAL BASIC, VISUAL FOX PRO, JAVA, HTML, XML, and the like. Any programming should allow for a license to install a client software application on the customer's servers, namely web, e-mail, video, other servers, and the like. The server software will be installed on the SP NOC sites. These software applications may perform the following functions:

Client Site Processes
Sampling (recording/capturing) of customer pre-determined at-risk data
Stamping time and date of all data captured
Storing this data in a secure storage device such as a SAN/NAS (customer site)
Transmitting captured data and log file on a pre-determined schedule to the server
Creating a log file of all data capture transactions
Synchronizing with the clocking system to ensure accurate time stamping
Encrypting and securing any data as determined by the customer

Server Site Processes
Sampling (recording/capturing) of customer pre-determined at-risk data on local remote accessed customer web site terminal
Stamping Time and date of all data captured
Storing this data in a secure storage device such as a SAN/NAS
Transmitting captured data and log file on a pre-determined schedule to the other server sites
Creating a log file of all data capture transactions
Synchronizing with the clocking system to ensure accurate time stamping
Encrypting and securing any data as determined by the customer
Internal sampling and validation processes to ensure the system is working effectively

It is anticipated that at the customer's location the client software application may be installed on the customer's server, namely web, e-mail, video, other server, and the like. This software will capture the web server at-risk data as defined in the contract (web content or specific data) with the SP. A copy of all e-mails that are pre-determined for capture may be forwarded (cc:) from the customer's e-mail server to a special storage device (this may require additional hardware) located on the customer's site and securely stored for transmission at a later date.

Those out going e-mails requiring the VC process should be setup in a special file on the e-mail server to automatically forward a copy to a special storage file that can not be accessed by the customer. This file should also be secure and only accessible by the SP. This file could be transmitted through a batch file process on a pre-determined schedule.

In many situations third party custom software applications may need to be developed to allow an interface with the customer's e-mail server. Prominent e-mail servers such as those sold under the trade name EXCHANGE SERVER by Microsoft may be able to operate without this software interface.

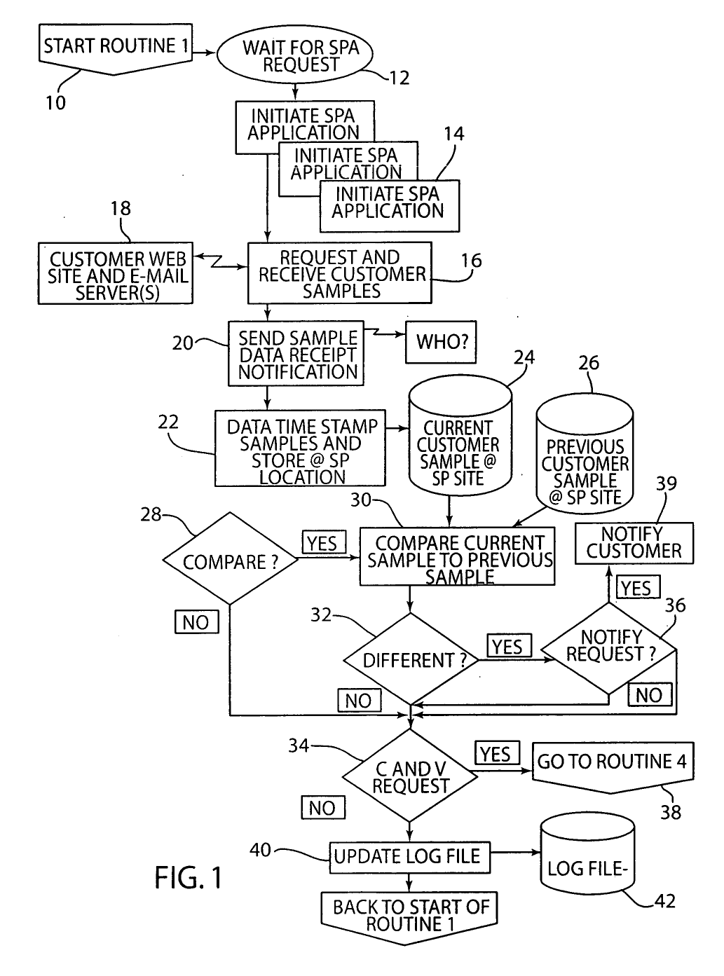

Referring now to the figures, a preferred embodiment of the present invention is illustrated generally in FIGS. 1-4. The present invention is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

As illustrated in FIG. 1, one embodiment of present invention system may be illustrated as a flow diagram that includes an initiation step 10, which results in a “Wait for Service Provider (SP) Request” 12. This is the initiation of starting the program. When such a request is received at Step 14, a request and contemporaneous receipt of customer data samples is requested and received at Step 16 from Customer site 18. When data is received from Step 16 at step 20, the system sends a receipt notification back to step 16. Next the system may proceed to Step 22, where the data is accurately date and time stamped as described above and stored at the SP site 24. It is noted that once the data is time stamped, whether it be at site 24 (or any other data storage site such as Sites 26, 82, 84, 110 (described below), and the like, may be optionally sent in an exact duplicate to at least one other site known in the art that may be separated geographically to ensure recovery of the data.

Next the system may optionally request at Step 28 a comparison of Data received at Stepl6 with Data previously received and stored (archived) at SP site 26. If the option is to compare, the system may proceed to Step 30 where current data from Site 24 is compared to previously sampled data from Site 26 then proceeds to Step 32 where the determination is made if there are differences among the two sets of data. If yes (i.e., differences were found), the system proceeds to Step 36 where the System has the option to Notify the Customer 39 (or alternatively the SP) or to proceed to Step 34 where a determination is made as to whether to request certification and/or verification. Also, if there is a determination that no differences where found in Step 32, the system similarly proceeds to Step 34.

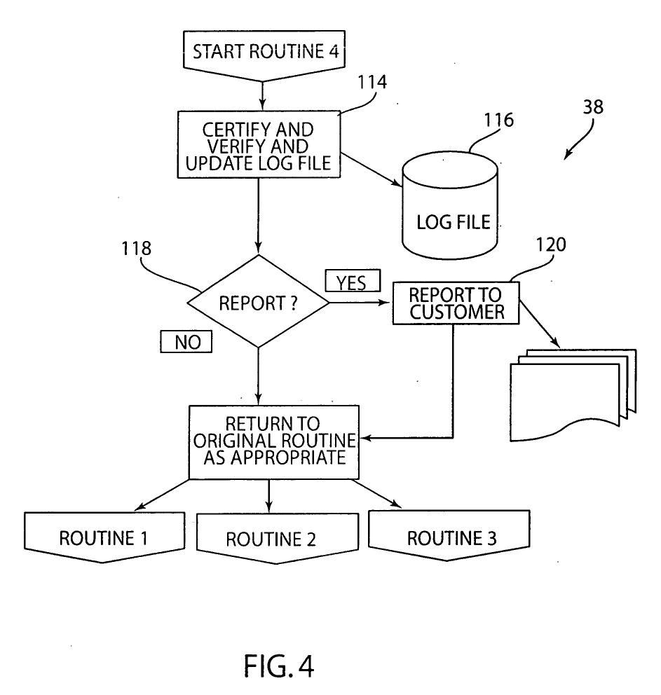

If at Step 34 the determination. is made to proceed with a certification and/or verification request, the system proceeds to Step 38, which is described more completely below and in FIG. 4. If at Step 34 the determination is made not to proceed with a certification and/or verification request, the system proceeds to Step 40 to update Log File 42, then returns to Step 12 to await another SPA request. Please note that in this system and throughout all aspects of this invention, any optional determinations or requests may be predetermined or made by a user or service provider and still fall within the scope of the invention.

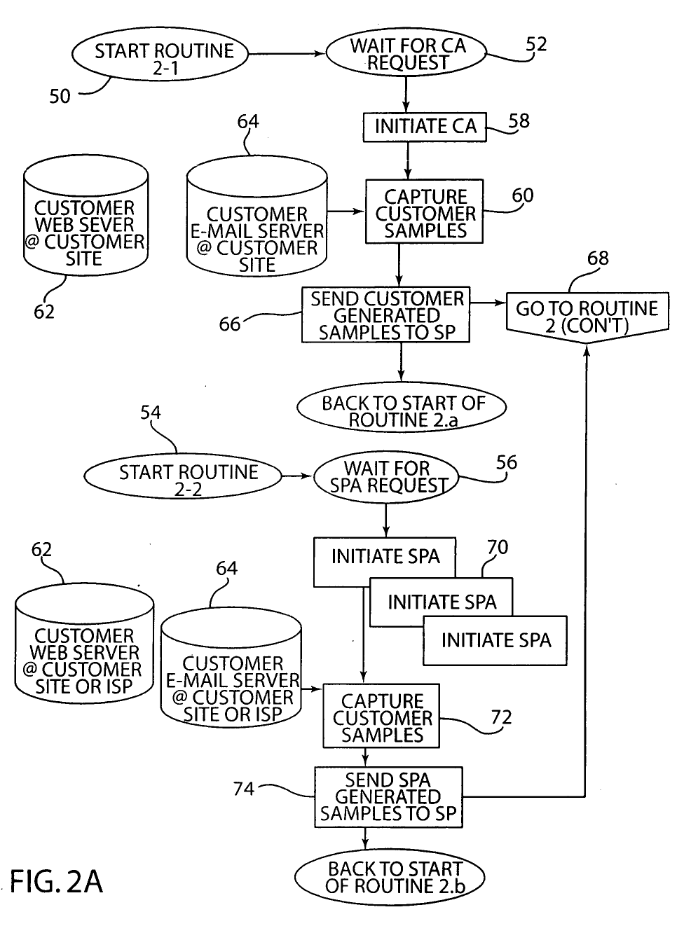

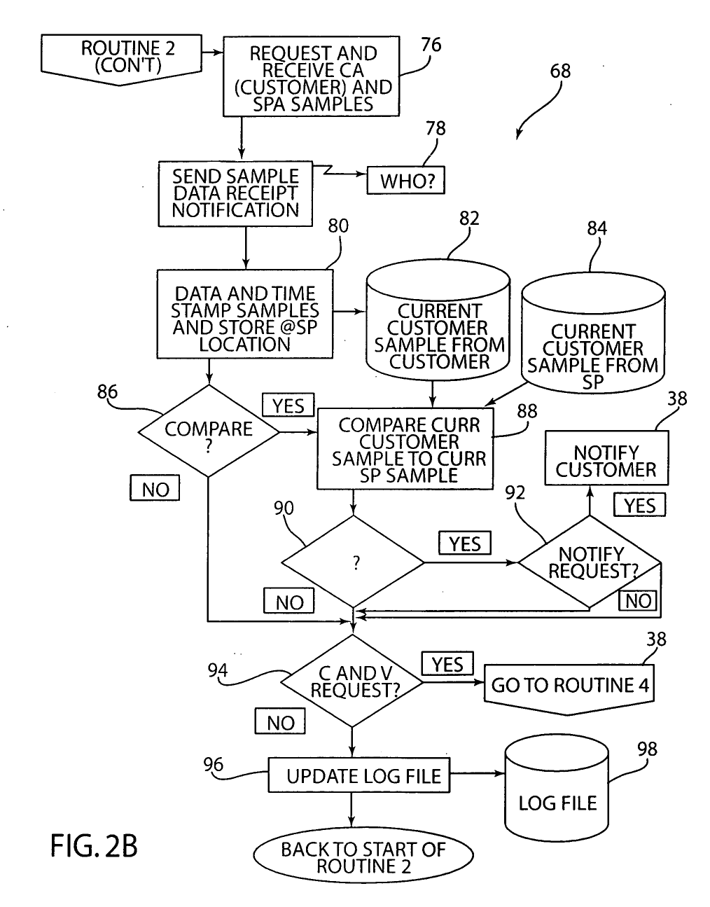

Referring now to FIG. 2, there is illustrated in FIG. 2a the initial steps of a second application of the present invention. In this embodiment, rather than sampling data at different times, data is sampled simultaneously from a customer application and a service provider application. It is noted that this embodiment may be operating separate to or in addition to the first embodiment. Specifically, Routine 2-1, initiated at Step 50, involves requests by a Customer Application (CA) at Step 52, while and Routine 2-2, initiated at Step 54, involves requests by a Service Provider Application (SPA) at Step 56.

As to Routine 2-1, the CA is initiated at Step 58, which leads to capturing of customer data at Step 60 from, for example, from a customer WebServer 62 or a customer E-mail server 64. The routine proceeds to Step 66 and sends CA generated data samples to the SP then continues to Step 68, described below and more specifically in FIG. 2b.

As to Routine 2-2, the SPA is initiated at Step 70, which leads to capturing of customer samples at Step 72 from, for example, from a customer WebServer 62 or a customer E-mail server 64. The routine proceeds to Step 74 and sends SPA generated data samples to the SP then continues to Step 68, described below and more specifically in FIG. 2b.

Referring now to FIG. 2b, Step 68 of a second potential application of the present invention beginning at Step 76 to Request and Receive both CA and SPA samples. When data is received from Step 76, the system sends a receipt notification back to step 76 at Step 78. Next the system may proceed to Step 80, where the data is accurately date and time stamped as described above and where current customer data from the CA is stored at site 82, and where current customer data from the SPA is stored at site 84.

Next the system may optionally request at Step 86 a comparison of Data stored at site 82 with Data stored at site 84. If the option is to compare, the system may proceed to Step 88 where site 82 and 84 Data are compared then proceeds to Step 90 where the determination is made if there are differences among the two sets of data. If yes (i.e., differences were found), the system proceeds to Step 92 where the System has the option to Notify the Customer 38 (or alternatively the SP) or to proceed to Step 94 where a determination is made as to whether to request certification and/or verification. Also, if there is a determination that no differences were found in Step 90, the system similarly proceeds to Step 94.

If at Step 94 the determination is made to proceed with a certification and/or verification request, the system proceeds to Step 38, which is described more completely below as Routine 4 and illustrated in FIG. 4. If at Step 94 the determination is made not to proceed with a certification and/or verification request, the system proceeds to Step 96 to update Log File 98, then returns to Steps 50 and 54 to await another request.

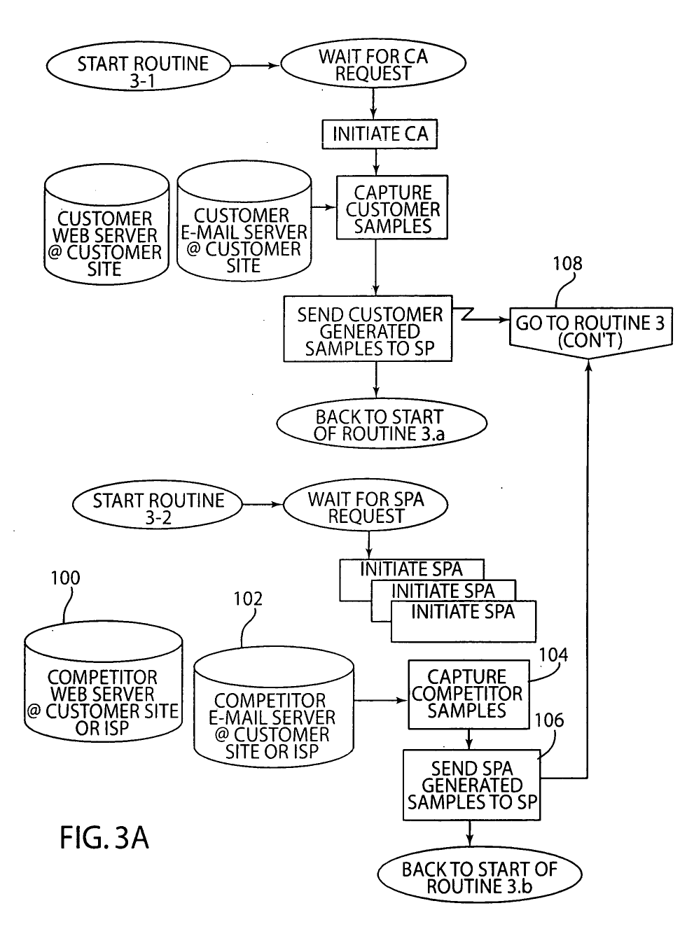

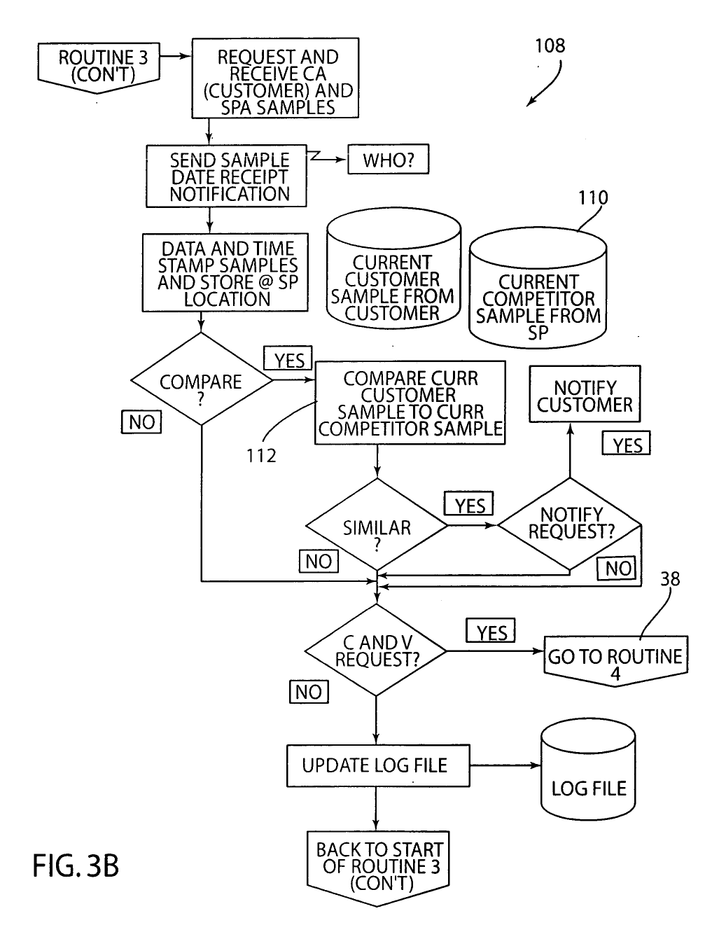

FIG. 3 illustrates another embodiment of the present invention that may also be practiced separate or in addition to the other illustrated embodiments. As shown in FIG. 3a, Routine 3-1 is similar to Routine 2-1, so further description is not needed. As to Routine 3-2, a key difference is the sampling of yet another source of data, here it is derived from a competitor's WebServer at a Customer site or ISP 100 or a competitor' E-mail server at a customer site or ISP 102. As to Routine 3-2, capturing of Data from sites 100 and 102 occurs at Step 104. The routine proceeds to Step 106 and sends SPA generated data samples to the SP then continues to Step 108, described above comparable to Step 68, and illustrated more specifically in FIG. 3b. FIG. 3b differs in that a Current competitor sample 110 is compared at Step 112 with the current customer data sample.

Referring to FIG. 4 is shown Routine 4, generally shown at 38, in response to a system request to proceed with a certification and/or verification request. Here, the system may certify and/or verify the data at step 114 and creates a log file 116. The system next proceeds to Step 118 for a determination of whether to generate a report 120. Otherwise, the system returns to its beginning. In this Routine, as noted above, the system may verify or certify the data. To aid in understanding these terms, one way to practice the invention is to have an electronic verification. Such verification may be achieved by first taking an electronic snapshot. Verification may be through comparing the data, images, or whatever data has been captured with data contemporaneously captured by another source. As an alternative, a single snapshot may suffice if a process to test system integrity is also employed. This may be achieved through test snap shots at random or at predetermined intervals and comparing the data captured (with log files of results).

Certification is an optional and additional step that would include the system provider performing a process or group of processes, manual or electronic, which confirms and attests to the true and accurate content of captured electronic data. This would be done in a manner configured, for example, to be admissible by a fact finding body, such as a court of law. Further, certification may include the addition of an authenticating mark such as by a manual seal known in the art, or by other means such as an electronic means such as a tamperproof embedding of a service mark of the SP or its licensor, a secret code requirement to open the document, encryption, or other means known in the art.

Other error checking processes may be used such as the system provider manually comparing data collection with the source or alternate data collection points.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

The invention claimed is:

1. A system to provide confirmation of content of an electronic data sample on which consumers may rely, comprising:
a system to capture a data sample;
a database interface for accessibly storing said data sample upon initiation of a system request;
an interface to accurately date and time stamp contemporaneously received data sample;
an interface to compare content of predetermined data sample sets; and
a notification report upon detection of predetermined differences.

2. A system to provide confirmation of content of an electronic data sample on which consumers may rely, comprising:
a system to capture a data sample;
a database interface for accessibly storing said data sample upon initiation of a system request;
an interface to accurately date and time stamp received data sample;
a third party interface to verify data sample content using predefined parameters; and
a system generated verification report.

3. The system of claim 2, further comprising a system for a third party interface to certify data samples.

4. The system of claim 2, further comprising at least one other data sample.

5. The system of claim 4, wherein said at least one other data sample is a data sample captured contemporaneously by another service provider server at a different geographic location.

6. The system of claim 2, wherein said system request is made by a Service Provider Application.

7. The system of claim 2, wherein said system request is made by a Customer Application.

8. The system of claim 2, wherein said data samples are contemporaneously captured customer sample data.

9. The system of claim 8, wherein said data samples further comprise archived customer sample data from customer.

10. The system of claim 9, wherein said data samples further comprise archived customer sample data from Service Provider.

11. The system of claim 10, wherein said data samples further comprise competitor WebServer sample data.

12. The system of claim 11, wherein at least two datasets are compared.

13. The system of claim 2, wherein said date and time stamping are recorded using a stratum level clock.

14. The system of claim 2, wherein said database interface for accessibly storing said data samples is located at least two separate geographic locations, each providing identical copies of said data sets.

15. The system of claim 2, wherein said electronic data sample is selected from the list comprising: electronic files, websites, e-mails, newsgroups, MP3's, instant messages, streaming video, audio, Internet packets, and Internet Protocols.

16. The system of claim 2, wherein said certification further comprises authentication of said certification by means selected from the list comprising: tamperproof embedding of a service mark, a secret code requirement to open the document, and encryption.

17. A method confirming content of an electronic data sample on which consumers may rely, comprising the steps of:
initiating a system request;
capturing said data sample;
storing said data sample accessibly in a database interface;
stamping an accurate date and time stamp contemporaneous with capturing said data sample;
comparing content of predetermined data sample sets; and
notifying a pre-selected party upon detection of predetermined differences.

18. A method of confirming content of an electronic data sample on which consumers may rely, comprising the steps of:
initiating a system request;
capturing said data sample;
storing said data sample accessibly in a database interface;
stamping an accurate date and time stamp contemporaneous with capturing said data sample;
verifying through a third party interface said data sample content using predefined parameters; and
generating a report.

19. The method of claim 18, further comprising the step of certifying data samples by a third party.

20. The method of claim 19, wherein said step of certifying said data comprises the step of authenticating said certification by means selected from the list comprising:
embedding a tamperproof service mark, requiring a secret code to open the document, or encrypting said file.
